(19) United States
(12) Patent Application Publication
(10) Pub. No.: US 2011/0015798 A1
(43) Pub. Date: Jan. 20, 2011

(54) Building Energy Usage Auditing, Reporting, and Visualization

(75) Inventors: Matt Golden, San Francisco, CA (US); Adam Winter, Emeryville, CA (US)

Correspondence Address: PATENTBEST, 4600 ADELINE ST., #101, EMERYVILLE, CA, 94608, US

(73) Assignee: SUSTAINABLE SPACES, INC., San Francisco, CA (US)

(21) Appl. No.: 12/506,157

(22) Filed: Jul. 20, 2009

(51) Int. Cl. G06F 1/28; G06G 7/63; G06F 3/048

(52) U.S. Cl. 700/291; 703/18; 715/772; 700/286

(57) ABSTRACT

Systems and methods for energy monitoring and for providing the user with contextual information on the energy usage of a building area are disclosed. The methods may comprise performing an energy audit of a building and using the audit data and a building physics simulator to construct a computational model of the building's energy usage. An energy budget may be derived based on the computational model. The building's actual energy usage is reported with contextual information on energy usage from the computational model, the energy budget, historical data on energy usage, and other sources. The systems generally include energy monitoring hardware, a building physics simulator engine, and an interface. The interface may be implemented in hardware or software. The components of the system may be located in one building, or a central monitoring station with a building physics simulator engine may communicate with energy monitoring hardware in several buildings.

### BACKGROUND OF THE INVENTION

1. Field of the Invention

Generally, the invention relates to the field of building science, and more particularly, to systems and methods for auditing, reporting, and visualizing building energy usage.

2. Description of Related Art

Recently, many people have begun to realize the benefits—both financial and environmental—of energy conservation and energy efficiency. As a movement toward energy-efficient buildings has grown, it has become clear that the amount of energy that any particular building uses is often poorly understood and poorly controlled. Historically, the amount of energy that any particular building used was a concern only to the extent that it was necessary to know how much energy was used in order to bill the user for it. However, successful energy conservation and energy efficiency often require far more detailed information than the overall amount of energy that has been consumed.

A building's energy usage is determined by a number of factors, some of which are under the control of the occupants and some of which are not. Factors such as the number of rooms, number and size of windows, building orientation, and quality and type of insulation are generally fixed and not under the control of the occupants, unless a retrofit or renovation is undertaken. The occupants also have no control over weather conditions, which may necessitate use of heating or air conditioning. However, certain factors, such as hot water usage, the actual thermostat temperature settings, and plug loads from appliances, are generally under the control of the occupants.

Over time, there have been efforts to make energy usage intelligible and actionable for the end user. International Application Publication No. WO08/092268 to Salter is illustrative of the typical types of technology on the market. The Salter publication discloses a meter that provides an indication of the cost and rate of electrical consumption, primarily by flashing a light at a rate that represents the rate of consumption. The Salter publication also illustrates the major problem with most of the available technology: it fails to provide context. Specifically, Salter fails to provide the building occupant with any mechanism for determining whether a high rate of consumption is acceptable or unacceptable considering all of the factors that affect energy usage. Thus, despite devices like that disclosed in Salter, basic questions are left unanswered: if a particular building used more energy this month than last, is that good or bad? If this year's winter energy usage was higher than last year, why was that the case? Without such contextual information on energy usage, the building occupants are often unable to make effective changes in their energy usage patterns.

### SUMMARY OF THE INVENTION

One aspect of the invention relates to a method for monitoring and reporting the energy usage of a building. The method comprises collecting energy-related information on a building, and using that information to create an energy model of the building. In some embodiments, collecting energy-related information may comprise performing an energy audit of a building to derive audit data. That energy model is used to derive contextual information on energy usage, actual energy usage of the building is measured, and the actual energy usage of the building is reported with the contextual information. In some embodiments, the reporting may comprise reporting the actual energy usage against a scale defined, at least in part, by the contextual information. That scale may take the form of a color gradient indicating contextually-appropriate low and high levels of energy usage. A variety of other graphical depictions may be used, and the actual energy usage and contextual information may be reported for different periods of time.

Another aspect of the invention relates to a system for monitoring and reporting the energy usage of a building. The method comprises a simulator, an energy monitor, and an interface. The simulator accepts energy-related information on a building, produces a computational model of energy usage, and derives contextual information about energy usage from the computational model. The energy monitor determines the actual energy usage for the building. The interface receives the actual energy usage for the building and the contextual information and reports the actual energy usage with the contextual information. The interface may display the actual energy usage against a scale defined, at least in part, by the contextual information. That scale may take the form of a color gradient indicating contextually-appropriate low and high levels of energy usage.

Yet another aspect of the invention also relates to a system for monitoring and reporting the energy usage of a plurality of buildings. The system comprises a simulator, a plurality of energy monitors, and an interface server. The simulator accepts energy-related information on a plurality of buildings, produces a computational model of energy usage for each of the plurality of buildings, and derives contextual information on energy usage for each of the plurality of buildings based on the respective computational models. Each of the plurality of energy monitors is adapted to determine the actual energy usage for one of the plurality of buildings. The interface server that receives the contextual information and the actual energy usage and communicates with one or more client devices using a communication network to report the actual energy usage with the contextual information. The interface server may provide data to the client devices that can be rendered to graphically depict the actual energy usages of the respective buildings against respective scales defined, at least in part, by the contextual information on energy usage.

Other aspects, features, and advantages of the invention will be apparent from the description that follows.

### BRIEF DESCRIPTION OF THE DRAWING FIGURES

The invention will be described with respect to the following drawing figures, in which like numerals represent like features throughout the figures, and in which:

FIG. 1 is a high-level flow diagram of a method according to one embodiment of the invention;

FIG. 2 is an illustration of one embodiment of a visual interface that may be used with systems and methods according to embodiments of the invention;

FIG. 3 is an illustration of another embodiment of a visual interface that may be used with systems and methods according to embodiments of the invention;

FIG. 4 is an illustration of yet another embodiment of a visual interface that may be used with systems and methods according to embodiments of the invention;

FIG. 5 is an illustration of a system according to one embodiment of the invention; and

FIG. 6 is an illustration of a system according to another embodiment of the invention.

### DETAILED DESCRIPTION

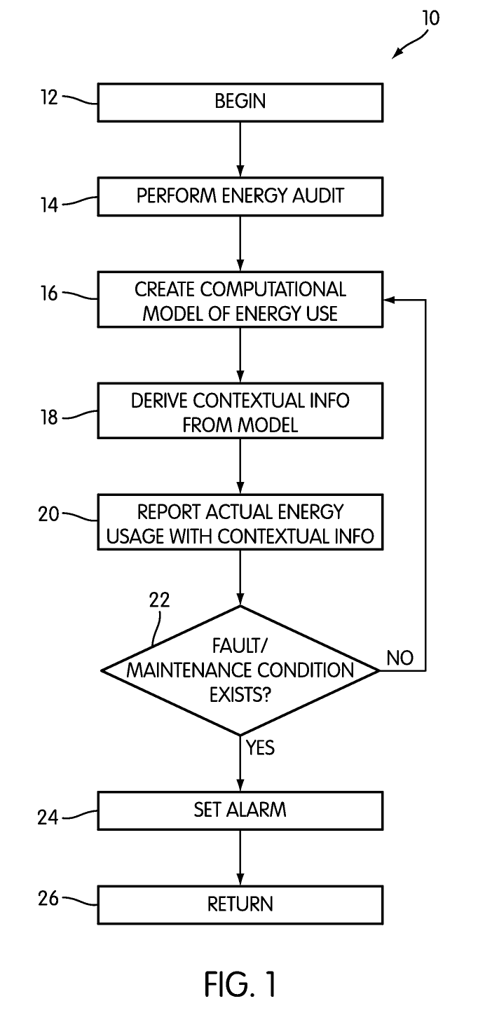

FIG. 1 is a high-level flow diagram of a method, generally indicated at 10, of reporting actual and contextual information on a building or structure's energy usage. It should be understood that method 10, and other methods and systems according to embodiments of the invention, may be applied to any form of occupied building or structure, including residential housing and commercial buildings. Additionally, the terms “building” and “structure” may be used interchangeably in the following description. Although the following description refers to the use of method 10 on an entire building, in some embodiments, and under certain circumstances, the tasks of method 10 may be performed on only a portion of a building. Additionally, although the term “energy” will be used in portions of the following description to describe the methods and systems and that which is being measured and reported, that term should be construed broadly to refer to any consumable commodity used by a building, including electricity, natural gas, oil, and water, to name a few.

Method 10 begins with task 12 and continues with task 14. In task 14, energy-related information is collected about a particular building. This may be done, for example, by performing an energy audit on the building. Generally speaking, the energy audit seeks to establish the basic set of building characteristics that determine its energy characteristics. Procedures for performing an energy audit of a building are known in the art, and professionals performing an energy audit generally examine such factors or elements as the dimensions and layout of rooms in the building; ceiling height; window dimensions, orientation, type. and the presence or absence of overhangs; building insulation quality, quantity, and type; overall building orientation; and internal heat loads from occupants, lighting, and equipment. If the building includes a heating or cooling system, the audit may also include an examination of the ductwork for leakage, heat loss, and insulation levels, as well as an evaluation of the heating and cooling equipment and other major appliances, their efficiency levels, and energy usage. Other factors may be known to those of skill in the art, and may be included in the energy audit of task 14. However, it should also be understood that although method 10 will be described as it would be applied to the entirety of a building's energy usage, in some embodiments of the invention, method 10 may be applied to only some of a building's energy usage, or only to energy usage from particular sources.

The energy audit of task 14 may take into account essentially any factors that affect or may potentially affect a building's energy usage. However, it may be advantageous if the procedures for the energy audit, and the elements reviewed, follow recognized industry standards. For example, the California Home Energy Rating System (HERS; California Code of Regulations, Title 20, Chapter 4, Article 8, Sections 1620-1675) and the building energy auditing standards promulgated by the Building Performance Institute, Inc. (BPI; Malta, N.Y.) are both suitable examples of industry-recognized auditing procedures.

However, it should be understood that method 10 need not include a full-scale, on-site energy audit in all embodiments. In some embodiments, satellite or other remote imaging, thermal imaging, utility bills, utility usage data, and other information sources may indicate significant issues or problems and may be sufficient for the purposes of method 10. Of course, if an energy usage parameter for a building is not directly measured or obtained, it could be indirectly measured or derived using appropriate assumptions and whatever data is available. As those of skill in the art will realize, it is advantageous if method 10 can be employed without a full, formal audit if it is not possible, practical, or desired to perform such an audit. It should also be understood that the work involved in performing the information collection or auditing tasks may be performed by a contractor, by the building occupants, or by some other party, depending on the embodiment. Building occupants may, for example, be provided with a questionnaire to fill out, either on paper or interactively via the World Wide Web.

Method 10 may be used in conjunction with a retrofit or renovation of an existing building or structure or it may be used on a new structure during the construction phase. Thus, the energy auditing methods used in task 14 of method 10 may be modified to suit the type of building on which the audit is being performed. For example, if the building is still under construction, data for the energy audit may be taken from the construction plans, from a site audit, or from any combination of those or other available sources.

Once the energy audit and/or information collection of task 14 is complete, method 10 continues with task 16, in which a model of the building's energy usage is constructed using the audit data from task 14. Generally speaking, in embodiments of the invention, the energy model will be a computational model, i.e., a simulation of the building's physics. However, other methods of determining characteristics of the building may be used as a part of method 10. For example, a standard reference work, such as the Air Conditioning Contractors of America's (ACCA) Manual J Residential Load Calculation (Air Conditioning Contractors of America, Inc., Arlington, Va., U.S.), may be used with the energy audit data to establish the building's minimum and maximum energy loads, and thereby to determine the size and characteristics of heating and cooling systems for that building. Standard reference works such as Manual J can also be used to establish other information used to understand energy usage, such as the average temperatures throughout the year.

The computational model of task 16 is essentially a simulation of how the building uses energy. Generally, the computational model of task 16 would be constructed using the energy audit data from task 14 and a building physics engine. A building physics engine is a software program that may be adapted to run either on a general purpose or special purpose computer, embedded system, or chipset that simulates a building's energy usage given a description of the building and the surrounding environment. (In more general terms, a building physics engine is a set of machine-readable instructions that are interoperable with a machine, such as a computer or microprocessor, to cause it to simulate some aspect of a building's energy usage.) Building physics engines typically provide a descriptive and/or programming language that can be used to describe the building and direct the desired energy modeling operations, as well as a facility for performing those operations. The building physics engine that is used may vary from embodiment to embodiment, but it may be advantageous if the building physics engine used in task 16 is a known and industry-recognized engine, such as the U.S. Department of Energy's DOE-2 building physics simulation engine, a product of the U.S. Lawrence Berkeley National Laboratory. As will be described below in more detail, information from the energy audit of task 14 may be provided to the building physics engine directly or through an interface with another software application (e.g., through an Application Programming Interface (API)).

The building physics engine is capable of determining a building's energy balance by simulation for any particular moment in time, using virtually any set of assumptions or data about external conditions or internal energy demand. For purposes of this description, the term “energy balance” refers to the total energy demand, which may be broken down by the source or nature of the demand, less any energy that is produced on-site (e.g., by photovoltaic cells). (In some embodiments, the building physics engine may also take into account environmental conditions to simulate how much energy is expected to be produced by on-site photovoltaic cells or other on-site energy generators.) The precise nature of the assumptions used in creating the simulation, and the output of the simulation itself will vary from embodiment to embodiment and from building to building.

In method 10, the computational model of the building's energy usage that is produced in task 16 is used as context, against which the building's current energy usage is reported, thus providing the user a means to understand the building's energy consumption. Specifically, in task 18 of method 10, contextual information on energy usage is derived from the computational model of task 16.

The contextual information on energy usage may be directly derived from the computational model, indirectly derived from the model, or some combination of both. For example, it may be advantageous in some embodiments to provide the user with the moment-by-moment results of the computational model so as to provide a direct comparison of the amount of energy that is used versus the amount of energy that the building ideally would or should use under particular conditions. However, it should be understood that although some of the description that follows may describe the use of energy simulation methods and systems on a continuous basis, any energy model constructed as a part of method 10 may or may not be used on a continuous basis. For example, an energy model may be run only once to establish contextual information.

Generally speaking, embodiments of the invention may employ the concept of performance-based energy budgeting with energy allocation based on a combination of regulatory requirements and occupant choices. More particularly, in most locations and legal jurisdictions, building code, common practice, or some combination of both may dictate that a building's heating and cooling systems should be sized and installed so as to keep the building above a specified minimum temperature on the coldest day of the year and below a specified maximum temperature on the hottest day of the year. Code or common practice may also specify, for example, that the building be equipped with a water heater of a particular size. Beyond that, the energy budget may be defined by the broad goals and choices of the occupants or designers of the building, with energy allocated to particular building systems on an day-by-day, hour-by-hour, or moment-by-moment basis in accordance with those broad goals. Using this framework, the contextual information provided by the energy model helps building occupants and others to understand whether they are meeting the budgeted energy goals or usage levels for the building.

Of course, an emphasis on performance-based energy budgeting and broad goals does not preclude the application of method 10, and the contextual information it provides, to address highly specific goals and needs. For example, a particular emphasis may be placed on reducing plug loads in some buildings, and on reducing energy usage due to water heating in others.

One advantage of using an energy model is that it provides a great deal of flexibility in the nature and amount of contextual information that can be provided to the user. In some cases, it may be helpful to provide more than one type of contextual information to the user. For example, using the computational model and other sources, a building occupant may be provided with different forms of contextual information, including the theoretical energy usage for the building at any given moment derived directly from the computational model of task 16 using certain average or baseline assumptions and the current exterior temperature; an energy budget derived from the computational model; historical data based on the occupant and building's prior energy usage; and a calculation of the percentage reduction in energy usage that the building has achieved, relative to a target energy reduction goal. These different types of contextual information may be provided one at a time or simultaneously, and may be broken down over any slice of time, e.g., by minute, hour, day, month, or year. Note that although in most embodiments, at least some of the information will be derived from the computational model, not all of the contextual information used in method 10 need be derived from that model. Instead, as was noted above, some of the contextual information may be derived, for example, from the building's energy usage history.

Once the contextual information has been derived from the computational model or from other sources in task 18, method 10 continues with task 20, in which the building's actual energy usage is reported along with the contextual information. Task 20 may be accomplished in any number of ways with any number of textual or visual indications of energy usage. Additionally, as will be described below in more detail, the textual or visual indications of energy usage and the contextual information may be reported using a variety of hardware and software platforms, ranging from meter-like single-purpose devices within the building to graphical user interfaces (GUIs) provided by software executed on general purpose computers, smartphones, and portable computers.

As noted in FIG. 1, in task 20, the building's actual energy usage, or a relevant portion of it, is reported. The energy usage of a building may be obtained in any number of ways, including directly from electric, water, and gas meters; using electronic devices that sense the amount of current or gas flowing through a wire or pipe; through energy usage meters attached to particular electrical outlets; or through any other technique or combination of techniques known in the art.

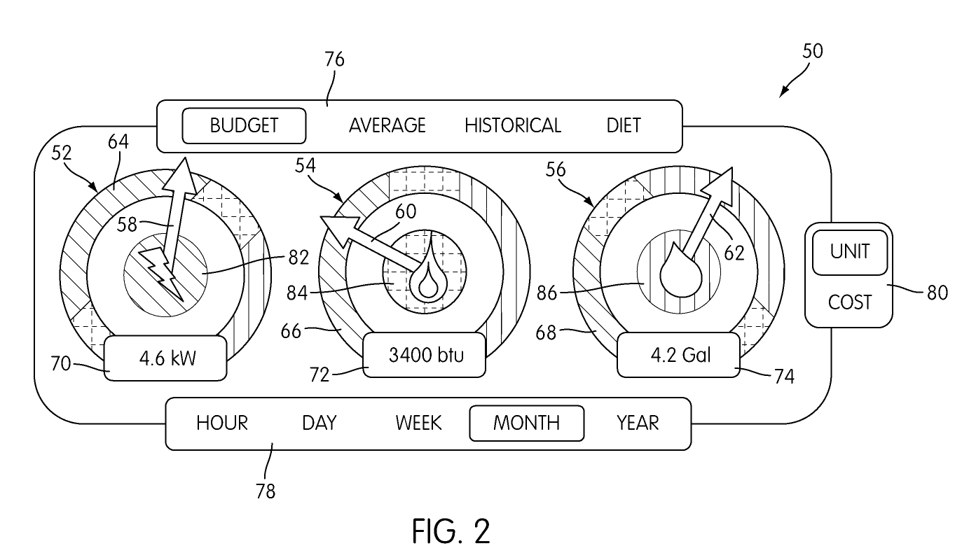

One way to report actual energy usage with the contextual information is to report the actual energy usage against a scale defined by the contextual information. FIG. 2 is an illustration of one embodiment of a visual interface, generally indicated at 50, that displays this sort of information. The visual interface 50 of FIG. 2 has three main simulated dials 52, 54, 56. In the illustrated embodiment, simulated dial 52 provides information on electricity usage, simulated dial 54 provides information on gas usage, and simulated dial 56 provides information on water usage. Each of the simulated dials 52, 54, 56 has a simulated indicator needle 58, 60, 62 shows the present energy usage in units defined by the contextual information. The simulated indicator needles 58, 60, 62 are read against a scale provided by the outer rings 64, 66, 68 of the dials 52, 54, 56.

The scale used in interfaces according to embodiments of the invention may vary from embodiment to embodiment and building to building. In the visual interface 50 of FIG. 2, the outer rings 64, 66, 68 define a scale that goes from “low” or “good” usage to “high” or “bad” usage, and use a color gradient to represent points on the scale between the lowest and highest values. Specifically, as shown in FIG. 2, the outer rings 64, 66, 68 have a color gradient that goes from green to yellow to red from left to right across the outer rings 64, 66, 68. With this color gradient scale, “green” means good or acceptable energy usage, “yellow” indicates borderline-high energy usage, and “red” indicates high energy usage. A separate indicator 70, 72, 74 in each simulated dial 52, 54, 56 provides the actual current energy usage value (in the illustration, 4.6 kW of electrical power, 3400 btu of gas, and 4.2 gallons of water).

One advantage of methods and systems according to embodiments of the invention is that the actual energy usage values that define low, borderline-high and high energy usage are defined by the contextual information derived in task 16 and may change as that information changes. For example, if the energy budget indicates that at this moment, the house should be using 4.4 kW of electrical power, then 10%, 20%, or 30% below that value might be considered the lower end of the scale as a “good” value and 10%, 20%, or 30% above that value might be considered the higher end of the scale as a “high” value. Different limits may be defined in different embodiments and for different buildings.

Additionally, the scale and definitions of low, borderline-high, and high energy usage may change in real time as conditions within and outside the building change. For example, the computational model can take into account factors like the current exterior temperature of the building. Therefore, on a hot day, the computational model would expect the building to be using its air conditioning systems, and on a cold day, the computational model would expect the building to be using its heating systems. Therefore, even if the building is consuming a large amount of energy running an air conditioner on a hot day or a heater on a cold day, the endpoints of the simulated dials 52, 54, 56 would be set such that the building may still be consuming an acceptable amount of energy when viewed against the theoretical energy usage for that day. In some embodiments, the computational model may be run hourly or on a moment-by-moment basis, such that heavy air conditioning usage during the hottest part of a day would read as good on the scale of visual interface 50, but if that usage level continued into cooler evening hours, the simulated needle 58 would read in the “red” area, indicating that the usage was high.

The visual interface 50 of FIG. 2 also allows the user or occupant to switch display modes. For example, a mode selector box 76 is provided at the top of the interface 50 that allows the user to select whether the contextual information that is currently being viewed is the energy budget, the average or theoretical energy usage, the building's historical energy usage, or the building's present energy conservation level relative to a predetermined energy “diet.” The interface 50 also provides a time selector 78 on the bottom that allows the user to select the time period for the contextual information—whether the contextual information is provided for the hour, week, month, day or year. A unit selector 80 on the right of the interface 50 allows the user to select between displaying the absolute quantities of energy that are being used and the total cost of energy that is being used.

In addition to allowing the user to view actual energy usage against a variety of different types of contextual information, the visual interface 50 also allows the user to simultaneously view actual usage versus contextual information in different time frames. Specifically, the outer rings 64, 66, 68 display the momentary or instantaneous energy consumption against the momentary or instantaneous contextual information. However, each simulated dial 52, 54, 56 also includes an inner ring 82, 84, 86 that indicates energy usage versus contextual information over a different, e.g., longer, period of time. In FIG. 2, for example, the outer ring 64 of the electricity dial 52 is green, indicating that at the moment, the building's energy usage is acceptable (the simulated needle 58 is at the edge of the green range), and since the inner ring 82 is also green, the building is also using an acceptable amount of energy for the week, month, or year.

In some embodiments, an interface like visual interface 50 may be implemented as a static display that always displays the same variables in the same way. However, most advantageously, visual interfaces used in methods and systems according to the embodiment are dynamically reconfigurable or software-reconfigurable such that the user can select which types of energy usage are to be monitored and which types of contextual information are to be displayed with actual energy usage. Thus, for example, a user could choose to display actual electrical usage against the computational model without displaying gas or water usage. Alternatively, a user may choose to display actual instantaneous electrical usage against the instantaneous results of the computational model (taking into account the current outside temperature) and use an inner ring or another type of secondary indicator to simultaneously show electrical usage against computational model results for the entire year. Various combinations are possible, and will be apparent to those of skill in the art.

Of course, although visual interfaces like that of FIG. 2 are useful in reporting results to the end user quickly and understandably, there may be situations in which more detailed information is desirable. Therefore, in some embodiments, the visual interface may also provide raw energy usage and contextual information in the form of a plot, graph, table, chart, or other comparative numerical format for the user's use. Such information may, in some embodiments, be made available by selecting a button on the interface, or by tapping on or selecting one of the simulated dials 52, 54, 56 to show detailed information.

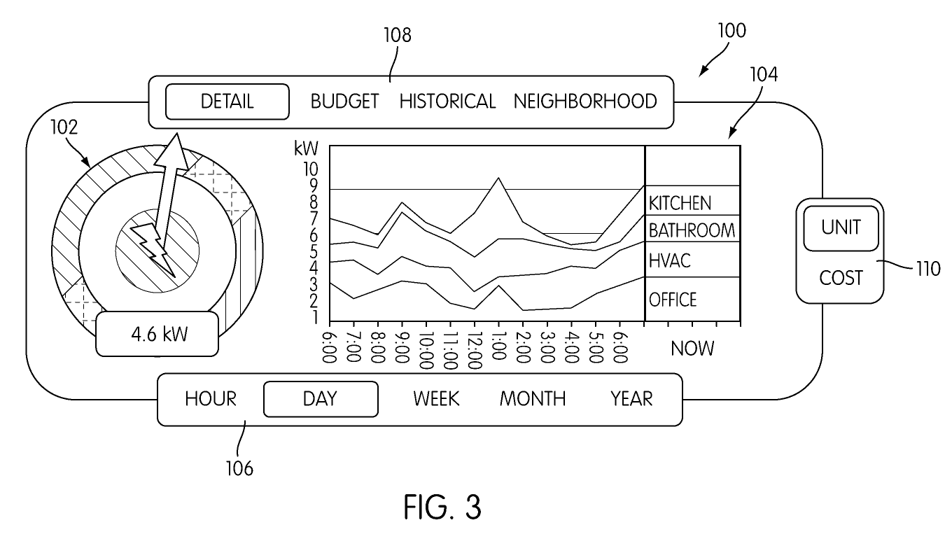

As one example, FIG. 3 is an illustration of another visual interface, generally indicated at 100. (Visual interface 100 may, in some embodiments, represent one mode or manner of displaying data using visual interface 50.) Visual interface 100 has two main elements, a simulated dial 102 that is configured in the illustration much like the simulated dial 52 of visual interface 50, and a graph or plot area 104. In FIG. 3, simulated dial 102 is displaying electrical usage. To the right of simulated dial 102, the graph area 104 displays a graph of the building's energy usage for the day, broken down by hour and by room (kitchen, bathroom, heating and air conditioning (HVAC) and office). A time selector 106 allows the user to select the time periods over which information is displayed (i.e., hour, day, week, month, and year), and a mode selector 108 allows the user to select the type of contextual information that is used with the simulated dial 102. Additionally, a unit selector 110 allows the user to select whether usage is displayed in terms of units of energy consumed, or in terms of the cost of those units of energy.

Visual interface 100 also illustrates the provision of another type of contextual information: energy usage for neighboring or comparable buildings. As will be explained below in more detail, in some embodiments, particularly if method 10 is being used simultaneously with multiple buildings in the same general area, or with comparable buildings, each user may be able to see at least some energy usage data for the other buildings.

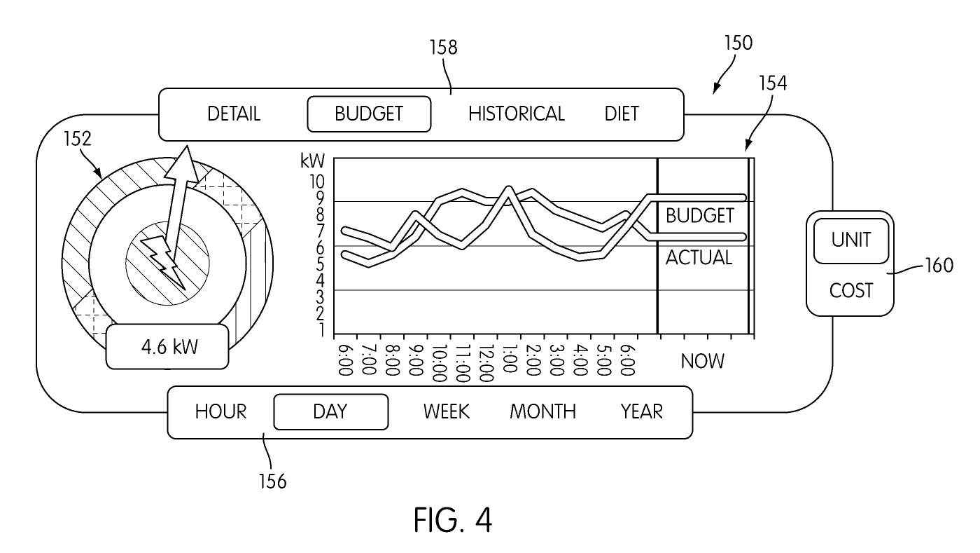

As another example, FIG. 4 is an illustration of another visual interface, generally indicated at 150. (Visual interface 150 may, in some embodiments, represent one mode or manner of displaying data using visual interface 50.) Like visual interface 100, visual interface 150 has two main elements: a simulated dial 152 and a graph or plot area 154. In the illustration of FIG. 4, the simulated dial 152 is displaying electrical energy usage while the graph area 154 displays a graph of the building's electrical energy usage for the day against a trend line indicating the building's energy budget for the day. As with the other interfaces 50, 100, the time frame shown in the graph area 154 is selectable using a time selector 156, so that the use can show energy usage for the week, month, year, or some other time frame, if desired. Additionally, visual interface 150 also includes a mode selector 158 and a unit selector 160 similar to those of the other interfaces 50, 100.

Of course, the interfaces 50, 100, 150 illustrated in FIGS. 2-4 are only examples of the ways in which actual energy usage may be reported with contextual information. In embodiments of the invention, the presentation of information may appear substantially different than what is described above, and in some embodiments, the presentation may be far simpler. For example, the current usage of any commodity may be presented against a background of a single color, with that single color indicating low, acceptable, or high usage of the commodity (e.g., a green background indicates low usage, a yellow background indicates acceptable-borderline usage, and a red background indicates that usage is high or does not meet the budget). Usage could also be presented with contextual information in the form of a graphical icon—e.g., a “thumbs up” icon for acceptable usage levels and a “thumbs down” icon for unacceptable usage levels. Alternatively, the presentation of usage with contextual information need not be graphical. For example, a building occupant may be sent an electronic mail message, an SMS text message, or some other form of textual communication indicating, e.g., “Electrical consumption currently 4.6 kW; BORDERLINE-nearing maximum budgeted consumption level” or some similar type of message.

With respect to method 10 of FIG. 1, once actual energy usage and contextual information are reported in task 20, method 10 may continue with task 22, which is optional and need not be included in all embodiments of the invention. Once method 10 is implemented, a wealth of information on actual and contextual information is collected. In some cases, that information may be used for more than simple energy monitoring. It may also be used to draw conclusions about a building's health and the efficacy and maintenance status of its systems. For example, when a system is breaking down, it sometimes draws more energy than it would if the system was working properly. Thus, a faulty motor may draw more current than one that is functioning properly. As indicated in task 22 of method 10, the energy usage and contextual data collected as a part of the method. Therefore, as one example, if a heating system is consistently drawing 10%, 20% or 25% more energy than it should be drawing, based on the computational model or the building's energy usage history, that is an indication that a condition requiring maintenance may exist in the heating system. If such a condition exists (task 22:YES), an alarm is raised in task 24 before method 10 returns at task 26. If no maintenance condition exists (task 22:NO), then method 10 may return to some earlier task, such as task 16, and be executed again. The thresholds that define that a maintenance problem is likely to exist may vary from embodiment to embodiment, building to building, and system to system, and the alarm that is raised may vary in nature, ranging from a visual indicator on the visual interface 50 to a periodic sound. As will be apparent from the above discussion, method 10 may be executed a number of times in series or parallel to provide substantially continuous monitoring of a building's energy usage over time. Method 10 may be performed using a variety of different types of systems.

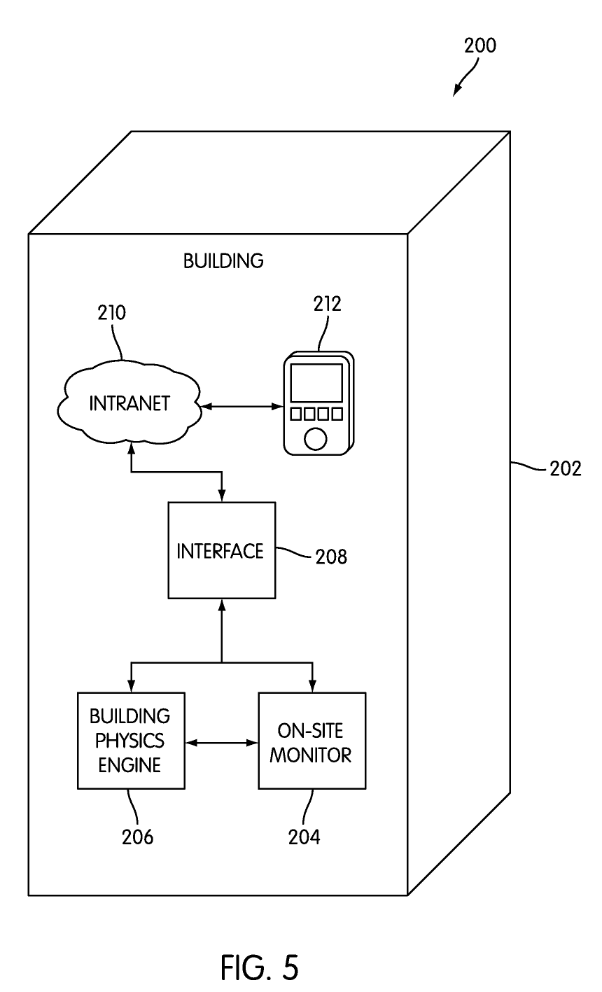

FIG. 5 is an illustration of a system, generally indicated at 200, according to one embodiment of the invention. In system 200, all of the components used to carry out methods according to embodiments of the invention are in the monitored building 202. As shown in FIG. 5, system 200 comprises three main components: an on-site monitor 204, a building physics engine 206, and an interface 208.

The on-site monitor 204 is shown in the illustration of FIG. 5 as a single component for ease of illustration. However, in embodiments of the invention, the on-site monitor may comprise all of the hardware, software, and other components that are used to detect and determine how much energy the building 202 is using. Therefore, the on-site monitor 204 may comprise one component or several components that communicate or cooperate with one another. Components of the on-site monitor 204 may include any of the energy measurement devices described above, including “smart” gas and electric meters, devices that measure the flow of current through a building's main supply lines by capacitative coupling, and plug-based outlet measurement systems. Additionally, if the building uses “smart” appliances that measure and report their own energy usage, the on-site monitor 204 may take input from, or include, those elements as well. The on-site monitor 204 coupled or connected to the building physics engine 206 and the interface 208 either by a wired connection (e.g., a building Ethernet network or universal serial bus (USB) connection to the other components) or by wireless connection (e.g., a building WiFi (IEEE 802.11) network).

The building physics engine 206 simulates the energy use of the building 202 and creates the computational model of the building's energy use that is used in methods according to embodiments of the invention. The building physics engine 206 may be implemented in hardware, software, or a combination of hardware and software. For example, in some embodiments, the building physics engine 206 may comprise a machine with hardware (e.g. a microprocessor or ASIC, memory, and associated input/output devices) that is permanently encoded with machine-readable instructions for performing the necessary simulations. This hardware may take the form of an embedded system that either stands alone or is included as a part of one of the other components of system 200, either the interface 208 or the on-site monitor 204.

In other embodiments, the building physics engine 206 may comprise a general purpose computer that is customized or adapted to perform the simulations. In this case, the customization or adaptation may comprise installing a software package (such as the sort of DOE-2 simulation software that is described above) on the general purpose computer without modifying the hardware, or it may comprise installing a software package and hardware components designed to make the simulations run more quickly and efficiently (e.g., additional memory, an additional processor or processors, etc.).

Alternatively, since building physics simulation software is well-known in the art and has been compiled for and ported to many different computing platforms, the building physics engine 206 may comprise a general purpose computer that is already present in the building with the appropriate software installed. Thus, for example, if the building 202 in question is a family home, the building physics engine 206 may comprise an existing family computer with the simulation software installed.

It should be understood that in addition to running the computational model, in some embodiments, the building physics engine 206 may also be responsible for comparing the input from the on-site monitor 204 with contextual information from the computational model or from other sources to provide the information that is ultimately reported to the user. Additionally, as was described briefly above, in some embodiments, the building physics engine 206 may be used only once, or a limited number of times, and may not form a permanent, real-time part of system 200.

The building physics engine 206 and on-site monitor 204 communicate with the interface 208, which is responsible for providing information to the user. The interface 208 may be a physical piece of hardware located in the building 202, in which case it may supplant a conventional thermostat and would display information essentially as described above with respect to the various visual interfaces 50, 100, 150. If the interface 208 is implemented in hardware, it would generally comprise a display; a mechanism for taking input from the user (which may be coupled to the display, as in the case of a touch screen); sufficient processing capability to drive the display and input mechanisms; and an input/output mechanism to connect with the building physics engine 206 and on-site monitor 204.

However, the interface 208 need not be a dedicated piece of hardware. In alternative embodiments, the interface 208 could be implemented in software on a general purpose or special purpose computer. If the interface 208 is implemented on a general or special purpose computer, it may be implemented on the same computer that is used for the building physics engine 206. Alternatively, if the building physics engine 206 is implemented on a special purpose computer, the interface 208 may be implemented using another general purpose computer in the building 202.

Additionally, as shown in FIG. 5, the interface 208, or another element of system 200, may communicate via a building intranet or building communications network 210 to provide interface functionality to other devices over the network 210. For example, a user may be able to access interface functionality through a smartphone, personal digital assistant (PDA), laptop, or other mobile device 212, either by a wired or wireless connection, depending on the nature of the device and the nature of the communications network 210. Using the communications network 210, in some embodiments, users may be able to access interface functionality from devices other than those on which the interface 208 is running using, for example, a World Wide Web-based interface.

As was described above, in system 200, all of the components needed to carry out a method like method 10 are resident in the building 202 that is being monitored. However, in other embodiments of the invention, it may not be necessary or desirable to place all of the elements in the building. It may be more cost-effective to create and run computational models for several buildings at one central location, such that components that have less computational power and are more easily installed and used can be placed in the individual buildings themselves. Additionally, as was noted above, it may not be necessary to provide a computational model for each building in real time.

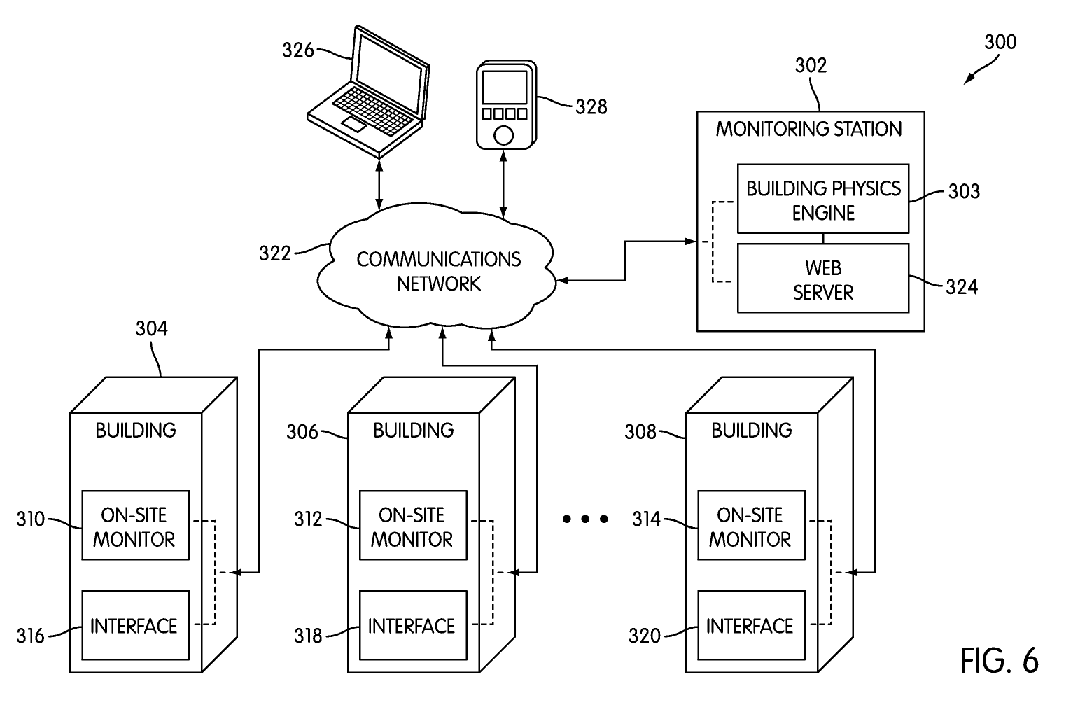

FIG. 6 is an illustration of a system 300 in which the above is true: a monitoring station 302 implements a building physics engine 303 that creates computational models for a plurality of buildings 304, 306, 308. In system 300, each of the buildings 304, 306, 308 may be different and located in a different geographical location, requiring different assumptions and data about the building's interior and exterior conditions. Each building 304, 306, 308 includes an on-site monitor 310 that is substantially similar to and performs the same functions as the on-site monitor 204 of system 200. The on-site monitors 310, 312, 314 communicate information to the off-site building physics engine 303 by means of a connection to a communications network 322 such as the Internet. Each building may also include a dedicated hardware or software-based interface 316, 318, 320 that performs much the same functions as the interface 208 of system 200.

However, system 300 and its use of a communications network 322 provides a particular advantage: any computing device that can connect to the network 322 and communicate with the monitoring station 302 can act as an interface, if the monitoring station communicates the appropriate information to it. Thus, for example, the monitoring station 302 may also maintain a World Wide Web server 324 that communicates with the building physics engine 303 and the respective on-site monitors 310, 312, 314 and provides interfaces via TCP/IP, hypertext transfer protocol (HTTP), and other Internet-based protocols to any device capable of communicating with it. (Information for each building may be secured by a password and/or login id, so that only authorized individuals are able to view information for a particular building.) As shown in FIG. 6, for example, a laptop 326 and smartphone 328 may connect to the monitoring station 302 through the communications network 322 to view energy usage information on any of the buildings 304, 306, 308, regardless of the location of the devices 326, 328. Typically, each device 326, 328 would include Web browser software capable of rendering an interface like the visual interfaces 50, 100, 150 described above.

If the functions of the building physics engine 303 are centralized in a monitoring station 302, the functions of methods according to embodiments of the invention may be offered as a subscription service for a yearly, monthly, or other regular fee. If that is done, some or all of the features may be offered on a subscription basis. For example, basic energy monitoring could be offered without regular charge, but monitoring for potential maintenance issues with equipment in the buildings 304, 306, 308 may be offered on a subscription basis.

Additionally, as was noted briefly above, when multiple buildings 304, 306, 308 are included in a system such as system 300, the interface 316, 318, 320 for each building may, in some embodiments, provide information on the energy usage of neighboring or comparable buildings as part of the visual interface provided to the user.

While the invention has been described with respect to certain embodiments, the embodiments are intended to be exemplary, rather than limiting. Modifications and changes may be made within the bounds of the invention, which is defined by the appended claims.

What is claimed is:

1. A method for monitoring and reporting the energy usage of a building, comprising:
collecting energy-related information about a building;
deriving contextual information on energy usage of the building by computationally modeling the energy usage of the building using the energy-related information;
measuring actual energy usage of the building; and
reporting the actual energy usage of the building with the contextual information on energy usage.

2. The method of claim 1, wherein the measuring and the reporting are performed substantially continuously.

3. The method of claim 1, further comprising deriving a yearly energy budget based on the contextual information on energy usage.

4. The method of claim 3, wherein the reporting further comprises reporting the actual energy usage of the building relative to the yearly energy budget.

5. The method of claim 1, wherein the reporting comprises reporting the actual energy usage of the building against an energy usage scale defined, at least in part, by the contextual information on energy usage.

6. The method of claim 5, wherein the reporting comprises reporting the actual energy usage against a background including at least one color indicating whether the actual energy usage is acceptable or unacceptable as defined by the contextual information on energy usage.

7. The method of claim 1, further comprising reporting the actual energy usage with the contextual information for different time periods.

8. The method of claim 1, wherein the building energy usage comprises usage of a plurality of consumables, and the method further comprises reporting the actual usage of each of the plurality of consumables against contextual information appropriate for each one of the consumables.

9. The method of claim 8, the reporting comprises reporting the actual usage of each of the plurality of consumables against a background for each consumable that includes a color gradient indicating whether the consumable usage is acceptable or unacceptable as defined by the contextual information.

10. The method of claim 1, further comprising determining, based on the actual energy usage of the building and the contextual information on energy usage, whether or not a condition requiring maintenance exists.

11. The method of claim 1, wherein the reporting comprises graphically depicting the instantaneous actual energy usage of the building against a scale defined, at least in part, by the contextual information on energy usage.

12. A system for monitoring and reporting the energy usage of a building, comprising:
a simulator that accepts energy-related information on a building, produces a computational model of energy usage, and derives contextual information about energy usage from the computational model;
an energy monitor that determines an actual energy usage for the building; and
an interface that receives the actual energy usage for the building and the contextual information and reports the actual energy usage with the contextual information.

13. The system of claim 13, wherein the interface comprises a hardware interface located within the building.

14. The system of claim 12, wherein the interface comprises a set of machine-readable instructions executed on a machine in communication with the simulator and the energy monitor.

15. The system of claim 14, wherein the machine comprises a portable device.

16. The system of claim 12, wherein the interface graphically depicts the actual energy usage of the building against a scale defined, at least in part, by the contextual information on energy usage.

17. The system of claim 16, wherein the scale comprises a color gradient defining acceptable and unacceptable levels of energy usage.

18. A system for monitoring the energy usage of a plurality of buildings, comprising:
a simulator that accepts energy-related information on a plurality of buildings, produces a computational model of energy usage for each of the plurality of buildings, and derives contextual information on energy usage for each of the plurality of buildings based on the respective computational models;
a plurality of energy monitors, each of the plurality of energy monitors being adapted to determine the actual energy usage for one of the plurality of buildings; and
an interface server that receives the contextual information and the actual energy usage and communicates with one or more client devices using a communications network to report the actual energy usage with the contextual information.

19. The system of claim 18, wherein the simulator and the interface server are remote from any of the plurality of buildings.

20. The system of claim 18, wherein the interface server provides data to the client devices that can be rendered to graphically depict the actual energy usages of the respective buildings against respective scales defined, at least in part, by the contextual information on energy usage.
